(19) United States
(12) Patent Application Publication
(10) Pub. No.: US 2024/0191325 A1
(43) Pub. Date: Jun. 13, 2024

(54) High-Recycled Content Beverage End Stock

(71) Applicant: Kaiser Aluminum Warrick, LLC, Newburgh, IN (US)

(72) Inventors: Thomas N. Rouns, Pittsburgh, PA (US); Christopher R. Miller, Newburgh, IN (US); Evan Thomas Quinley, Owensboro, KY (US)

(21) Appl. No.: 18/531,893

(22) Filed: Dec. 7, 2023

Related U.S. Application Data
(60) Provisional application No. 63/431,484, filed on Dec. 9, 2022.

(51) Int. Cl. C22C 21/00; C22F 1/04

(52) U.S. Cl. CPC C22C 21/00; C22F 1/04

(57) ABSTRACT

An aluminum alloy sheet includes an aluminum alloy composition. The aluminum alloy composition includes: a first component including recycled material and a second component including non-recycled material. The aluminum alloy composition includes a recycled content of at least 30%. An aluminum alloy composition, a method of making an aluminum alloy sheet, a method of making an aluminum alloy package, and a method of making an aluminum alloy composition are also provided.

### CROSS-REFERENCE TO RELATED APPLICATIONS

This application claims priority to U.S. Provisional Application No. 63/431,484, filed Dec. 9, 2022, the disclosure of which is incorporated by reference herein in its entirety.

### BACKGROUND OF THE INVENTION

### Field of the Invention

This invention relates to aluminum alloy compositions that include at least 30% recycled content, aluminum alloy sheets produced from aluminum alloy compositions that include at least 30% recycled content, and methods of making the aluminum alloy sheet, the aluminum alloy composition, and aluminum alloy packages, such as beverage container ends.

### Technical Considerations

Aluminum alloys are widely used in the manufacture of aluminum containers, such as beverage cans and beverage ends. These aluminum alloys must be formable enough and strong enough to withstand the processes for forming the final aluminum container, the processes for beverage processing within the container, and distribution.

Aluminum containers and aluminum scrap from industrial processes can be recycled and used to prepare other aluminum products. For example, used beverage can (UBC) scrap is aluminum scrap that is collected from used beverage cans, and can include a mixture of several different aluminum alloys. Aluminum scrap from industrial processes, such as from building, transportation, and printing processes, can also be recycled. Like UBC, scrap from industrial processes can also include a mixture of several different aluminum alloys. The aluminum scrap from UBC and industrial processes can be combined, processed, melted, and then used for producing new aluminum products. However, this aluminum scrap can include impurities and/or undesirable amounts of alloying components.

### SUMMARY OF THE INVENTION

The achieve the appropriate balance of alloying components, material strength, and formability, aluminum scrap can be combined with sufficient amounts of prime aluminum and alloying elements. It would be desirable to produce an aluminum alloy composition that uses high amounts of aluminum scrap material and low amounts of prime aluminum and alloying elements that can be used to form an aluminum alloy sheet that meets the formability and strength requirements for manufacturing and processing beverage container ends.

The invention relates to an aluminum alloy sheet. The aluminum alloy sheet comprises an aluminum alloy composition. The aluminum alloy composition comprises a first component comprising recycled material; a second component comprising non-recycled material; and an optional third component comprising mill scrap. The aluminum alloy composition comprises a recycled content of at least 30%.

The invention relates to an aluminum alloy sheet. The aluminum alloy sheet comprises an aluminum alloy composition. The aluminum alloy composition comprises a first component comprising recycled material; a second component comprising non-recycled material; and an optional third component comprising mill scrap. The aluminum alloy composition comprises a recycled content of at least 30%. The aluminum alloy sheet is a coated aluminum alloy sheet.

The invention also relates to an aluminum alloy composition. The aluminum alloy composition comprises a first component comprising recycled material; a second component comprising non-recycled material; and an optional third component comprising mill scrap. The aluminum alloy composition comprises a recycled content of at least 30%.

The invention also relates to a method of making an aluminum alloy sheet. The method comprises: providing an aluminum alloy composition, wherein the aluminum alloy composition comprises: a first component comprising recycled material; a second component comprising non-recycled material; and an optional third component comprising mill scrap, wherein the aluminum alloy composition comprises a recycled content of at least 30%; casting the aluminum alloy composition to produce an aluminum alloy ingot; and rolling the aluminum alloy ingot to produce an aluminum alloy sheet.

The invention also relates to a method of making an aluminum alloy sheet. The method comprises: providing an aluminum alloy composition, wherein the aluminum alloy composition comprises: a first component comprising recycled material; a second component comprising non-recycled material; and an optional third component comprising mill scrap, wherein the aluminum alloy composition comprises a recycled content of at least 30%; casting the aluminum alloy composition to produce an aluminum alloy ingot; rolling the aluminum alloy ingot to produce an aluminum alloy sheet; and coating the aluminum alloy sheet to form a coated aluminum alloy sheet.

The invention also relates to a method of making an aluminum alloy package. The aluminum alloy package is a beverage container end. The method comprises: obtaining an aluminum alloy sheet, wherein the aluminum alloy sheet comprises an aluminum alloy composition comprising: a first component comprising recycled material, a second component comprising non-recycled material, and an optional third component comprising mill scrap, wherein the aluminum alloy composition comprises a recycled content of at least 30%; and forming the aluminum alloy sheet into an aluminum alloy package.

The invention also relates to a method of making an aluminum alloy package. The aluminum alloy package is a beverage container end. The method comprises: obtaining an aluminum alloy sheet, wherein the aluminum alloy sheet comprises an aluminum alloy composition comprising: a first component comprising recycled material, a second component comprising non-recycled material, and an optional third component comprising mill scrap, wherein the aluminum alloy composition comprises a recycled content of at least 30%; coating the aluminum alloy sheet to form a coated aluminum alloy sheet; and forming the coated aluminum alloy sheet into an aluminum alloy package.

The invention also relates to a method of making an aluminum alloy composition. The method comprises: obtaining a first component, wherein the first component comprises recycled material; obtaining a second component, wherein the second component comprises non-recycled material; melting the first component; melting the second component; blending the first component and the second component together to form the aluminum alloy composition, wherein the aluminum alloy composition comprises a recycled content of at least 30%.

The invention also relates to a method of making an aluminum alloy composition. The method comprises: obtaining a first component, wherein the first component comprises recycled material; obtaining a second component, wherein the second component comprises non-recycled material; optionally obtaining a third component, wherein the third component (if present) comprises mill scrap; melting the first component; melting the second component; melting the third component (if present); blending the first component, the second component, and the third component (if present) to form the aluminum alloy composition, wherein the aluminum alloy composition comprises a recycled content of at least 30%.

### DESCRIPTION OF THE INVENTION

It is to be understood that the invention can assume various alternative orientations and, accordingly, such terms are not to be considered as limiting. Further, as used herein, all numbers expressing dimensions, physical characteristics, processing parameters, quantities of ingredients, reaction conditions, and the like, used in the specification and claims are to be understood as being modified in all instances by the term “about”. Accordingly, unless indicated to the contrary, the numerical values set forth in the following specification and claims may vary depending upon the desired properties sought to be obtained by the present invention. At the very least, and not as an attempt to limit the application of the doctrine of equivalents to the scope of the claims, each numerical value should at least be construed in light of the number of reported significant digits and by applying ordinary rounding techniques. Moreover, all ranges disclosed herein are to be understood to encompass the beginning and ending range values and any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more and ending with a maximum value of 10 or less, e.g., 1 to 3.3, 4.7 to 7.5, 5.5 to 10, and the like. “A” or “an” refers to one or more.

As used herein, reference is made to alloys identified by aluminum industry designations, such as “series” or “5xxx.” For an understanding of the number designation system most commonly used in naming and identifying aluminum and its alloys, see “International Alloy Designations and Chemical Composition Limits for Wrought Aluminum and Wrought Aluminum Alloys” published by The Aluminum Association. The tempers mentioned herein are as defined by the American National Standard Alloy and Temper Designation System for Aluminum ANSI H35.1.

The present invention relates to an aluminum alloy sheet. The aluminum alloy sheet comprises an aluminum alloy composition comprising a first component comprising recycled material and a second component comprising non-recycled material. The aluminum alloy composition comprises a recycled content of at least 30%.

The aluminum alloy composition used to form an aluminum alloy sheet may further comprise a third component comprising mill scrap. The amount of the third component is not included when determining the recycled content.

The present invention also relates to a coated aluminum alloy sheet. Both sides of the aluminum alloy sheet may be coated. The coated aluminum alloy sheet comprises an aluminum alloy composition comprising a first component comprising recycled material and a second component comprising non-recycled material. The aluminum alloy composition comprises a recycled content of at least 30%.

The aluminum alloy composition used to form a coated aluminum alloy sheet may further comprise a third component comprising mill scrap. The amount of the third component is not included when determining the recycled content.

The present invention also relates to an aluminum alloy composition. The aluminum alloy composition comprises a first component comprising recycled material and a second component comprising non-recycled material. The aluminum alloy composition comprises a recycled content of at least 30%.

The aluminum alloy compositions described herein may consist essentially of a first component and a second component. The aluminum alloy compositions described herein may consist of a first component and a second component.

The aluminum alloy composition may further comprise a third component comprising mill scrap. The amount of the third component is not included when determining the recycled content.

The aluminum alloy composition comprises a recycled content. As used herein, “recycled content” is a percentage that is calculated by dividing the amount, by mass, of the first component by the sum of the amounts, by mass, of the first component and the second component. The recycled content does not include the amount, by mass, of the third component.

The recycled content of the aluminum alloy composition may be at least 30%, such as at least 35%, at least 40%, at least 45%, at least 50%, at least 55%, at least 60%, at least 65%, at least 70%, at least 75%, at least 80%, at least 85%, at least 90%, at least 95%, or 100%. The recycled content of the aluminum alloy composition may be not greater than 95%, such as not greater than 90%, not greater than 85%, not greater than 80%, not greater than 75%, or not greater than 70%.

The recycled content of the aluminum alloy composition may range from 30% to 95%, such as from at least 30% to 90%, from 30% to 85%, from 30% to 80%, from 30% to 75%, from 30% to 70%, from 35% to 95%, from 35% to 90%, from 35% to 85%, from 35% to 80%, from 35% to 75%, from 35% to 70%, from 40% to 95%, from 40% to 90%, from 40% to 85%, from 40% to 80%, from 40% to 75%, from 40% to 70%, from 45% to 95%, from 45% to 90%, from 45% to 85%, from 45% to 80%, from 45% to 75%, from 45% to 70%, from 50% to 95%, from 50% to 90%, from 50% to 85%, from 50% to 80%, from 50% to 75%, from 50% to 70%, from 55% to 95%, from 55% to 90%, from 55% to 85%, from 55% to 80%, from 55% to 75%, from 55% to 70%, from 60% to 95%, from 60% to 90%, from 60% to 85%, from 60% to 80%, from 60% to 75%, from 60% to 70%, from 65% to 95%, from 65% to 90%, from 65% to 85%, from 65% to 80%, from 65% to 75%, from 65% to 70%, from 70% to 95%, from 70% to 90%, from 70% to 85%, from 70% to 80%, from 70% to 75%, from 75% to 95%, from 75% to 90%, from 75% to 85%, from 75% to 80%, from 80% to 95%, from 80% to 90%, from 80% to 85%, from 85% to 95%, from 85% to 90%, or from 90% to 95%.

The recycled material of the first component may comprise one or more 5xxx series aluminum alloys that have been collected as scrap. For example, the recycled material of the first component may include, but is not limited to: scrap Aluminum Association (AA) 5x54, such as scrap AA 5154, scrap AA 5254, scrap AA 5354, scrap AA 5454, scrap AA 5554, scrap AA 5654, scrap AA 5754, scrap AA 5854, or scrap AA 5954; scrap AA 5457; scrap AA 5085; scrap AA 5083; scrap AA 5086; scrap AA 5052; scrap AA 5352; scrap AA 5182; scrap AA 5042; scrap AA 5086; and combinations thereof. The recycled material of the first component may include, but is not limited to: remelted scrap ingot (RSI); post-industrial scrap; pre-consumer scrap; post-consumer scrap; Class I scrap; Class II scrap; Class III scrap; Class IV scrap; used beverage cans (UBCs); and combinations thereof. The recycled material of the first component may comprise scrap AA 5x54, such as scrap AA 5154, scrap AA 5254, scrap AA 5354, scrap AA 5454, scrap AA 5554, scrap AA 5654, scrap AA 5754, scrap AA 5854, or scrap AA 5954; scrap AA 5457; scrap AA 5085; scrap AA 5083; scrap AA 5086; scrap AA 5052; scrap AA 5352; scrap AA 5182; scrap AA 5042; scrap AA 5086; RSI; post-industrial scrap; pre-consumer scrap; post-consumer scrap; Class I scrap; Class II scrap; Class III scrap; Class IV scrap; used beverage cans (UBCs); and combinations thereof. The recycled material of the first component may comprise UBCs.

As used herein, “post-industrial scrap” refers to aluminum and aluminum alloy waste that is generated from an industrial process. For example, post-industrial scrap may be collected from an external metal processing facility or an external metal working facility. Post-industrial scrap may include aluminum sheets, cast aluminum products, aluminum wire, and other aluminum materials. The post-industrial scrap may include RSI, Class I scrap, Class Scrap II scrap, Class III scrap, and Class IV scrap. As used herein, “pre-consumer scrap” refers to aluminum and aluminum alloy scrap that arises from the various production stages of an aluminum or aluminum alloy product, before the aluminum or aluminum alloy product is sold to the final user. The pre-consumer scrap may include Class I scrap, Class Scrap II scrap, Class III scrap, and Class IV scrap. As used herein, “Class I scrap” refers to clean, body stock of the 3xxx series type and can include skeletons and trim, slitter balls and trim, and undecorated cans and cups. As used herein “Class II scrap” refers to 5xxx series alloys and can include skeletons and trims, slitter balls and trim, spoiled uncompounded ends, spoiled cans and cups, tab stock skeletons and particles, and mis-lithographed sheets. As used herein, “Class III scrap” refers to spoiled, decorated cans of AA the 3xxx series type. As used herein, “Class IV scrap” refers to spoiled compounded ends of the 5xxx series type.

As used herein “post-consumer scrap” refers to aluminum and aluminum alloys that have been used in a product that has gone through its complete life-cycle. Post-consumer scrap can be collected, for example, from a recycling facility, and may include but is not limited to aluminum packaging materials, painted aluminum building materials, aluminum food containers, aluminum beverage containers, or combinations thereof. Post-consumer scrap comprises UBCs. As used herein, “UBCs” are coated or uncoated packaging materials made of aluminum that are collected and sorted by a recycling facility, where the cans have been used by the consumer and are free of the beverage or food contents.

The scrap AA 5x54, such as scrap AA 5154, scrap AA 5254, scrap AA 5354, scrap AA 5454, scrap AA 5554, scrap AA 5654, scrap AA 5754, scrap AA 5854, or scrap AA 5954; scrap AA 5457; scrap AA 5085; scrap AA 5083; scrap AA 5086; scrap AA 5052; scrap AA 5352; scrap AA 5182; scrap AA 5042; scrap AA 5086; RSI; post-industrial scrap; pre-consumer scrap; post-consumer scrap; Class I scrap; Class II scrap; Class III scrap; Class IV scrap; UBCs; and combinations thereof may be melted and blended together to form the first component.

The second component comprises non-recycled material. The non-recycled material may comprise, but is not limited to prime aluminum, an alloying element, or combinations thereof.

The prime aluminum is smelted metal. The prime aluminum may comprise less than or equal to 0.16 weight percent (wt. %) silicon (Si) and less than or equal to 0.25 wt. % iron (Fc). The prime aluminum may comprise less than or equal to 0.10 wt. % Si and less than or equal to 0.20 wt. % Fe. The prime aluminum may comprise less than or equal to 0.10 wt. % Si and less than or equal to 0.15 wt. % Fe. The prime aluminum may comprise less than or equal to 0.06 wt. % Si and less than or equal to 0.10 wt. % Fe. The prime aluminum may comprise less than or equal to 0.04 wt. % Si and less than or equal to 0.06 wt. % Fe. The prime aluminum may comprise less than or equal to 0.02 wt. % Si and less than or equal to 0.02 wt. % Fc.

The alloying element may comprise one or more elements. For example, the alloying element may comprise one element. In another example, the alloying element may comprise two different elements, three different elements, four different elements, five different elements, or six different elements. The alloying element may comprise, but is not limited to: Si, Fe, copper (Cu), magnesium (Mg), manganese (Mn), titanium (Ti), and combinations thereof. In one example, the alloying element comprises Mg, Mn, Cu, or combinations thereof. The alloying element may be added to the aluminum alloy composition to provide the aluminum alloy sheet with the appropriate strength.

The non-recycled material of the second component may comprise prime aluminum and the alloying element. The non-recycled material of the second component may comprise prime aluminum and may not comprise the alloying element. The non-recycled material of the second component may comprise the alloying element and may not comprise prime aluminum.

The optional third component comprises mill scrap. As used herein, “mill scrap” refers to scrap aluminum and aluminum alloy materials that are generated during an internal industrial process or an internal manufacturing process, including defective or rejected products, and are subsequently internally collected. The mill scrap may comprise ingot scrap, casting scrap, RSI, hot roll processing scrap, cold roll processing scrap, uncoated coil scrap, coated coil scrap, and combinations thereof. Mill scrap is not considered part of the first component or the second component.

When the aluminum alloy composition comprises the third component, the third component may be present in the aluminum alloy composition in an amount that is not greater than 40 wt. %, such as not greater than 35 wt. %, not greater than 30 wt. %, not greater than 25 wt. %, or not greater than 20 wt. %, based on 100 wt. % of the aluminum alloy composition.

The aluminum alloy composition may comprise 100 wt. % of the first component, 0 wt. % of the second component, and 0 wt. % of the third component (i.e. the entire aluminum alloy composition is made from recycled material).

The aluminum alloy composition may comprise the first component in an amount from 30 wt. % to 100 wt. %, such as from 35 wt. % to 100%, from 40 wt. % to 100 wt. %, from 45 wt. % to 100 wt. %, from 50 wt. % to 100 wt. %, from 55 wt. % to 100 wt. %, from 60 wt. % to 100 wt. %, from 65 wt. % to 100 wt. %, from 70 wt. % to 100 wt. %, or from 30 wt. % to 70 wt. %; the second component in an amount from 0 wt. % to 70 wt. %, such as from 0 wt. % to 65 wt. %, from 0 wt. % to 60 wt. %, from 0 wt. % to 55 wt. %, from 0 wt. % to 50 wt. %, from 0 wt. % to 45 wt. %, from 0 wt. % to 40 wt. %, from 0 wt. % to 35 wt. %, from 0 wt. % to 30 wt. %, or from 30 wt. % to 70 wt. %; and 0 wt. % of the third component (i.e. there is no mill scrap added to form the aluminum alloy composition), based on 100 wt. % of the aluminum alloy composition.

The aluminum alloy composition may comprise the first component in an amount from 65 wt. % to 100 wt. %, such as from 70 wt. % to 100 wt. %, from 75 wt. % to 100 wt. %, from 80 wt. % to 100 wt. %; the third component in an amount that is not greater than 40 wt. %, such as 0 wt. % to 35 wt. %, 0 wt. % to 30 wt. %, 0 wt. % to 25 wt. %, or 0 wt. % to 20 wt. %; and 0 wt. % of the second component (i.e. there is no prime aluminum or alloying element added to form the aluminum alloy composition), based on 100 wt. % of the aluminum alloy composition.

The aluminum alloy composition may comprise a combination of the first component and the second component in an amount from 65 wt. % to 100 wt. %, such as 70 wt. % to 100 wt. %, 70 wt. % to 95 wt. %, 70 wt. % to 90 wt. %, 70 wt. % to 80 wt. %, or 65 wt. % to 75 wt. %, and the optional third component (if present) in an amount from 0 wt. % to 35 wt. %, such as from 0 wt. % to 30 wt. %, 5 wt. % to 30 wt. %, 10 wt. % to 30 wt. %, 20 wt. % to 30 wt. %, or 25 wt. % to 35 wt. %, based on 100 wt. % of the aluminum alloy composition.

The aluminum alloy composition may comprise the first component in an amount from 20 wt. % to 50 wt. %, such as from 30 wt. % to 50 wt. %, from 40 wt. % to 50 wt. %, or from 25 wt. % to 45 wt. %; the second component in an amount from 20 wt. % to 50 wt. %, such as from 20 wt. % to 40 wt. %, or from 25 wt. % to 45 wt. %; and the optional third component (if present) in an amount from 0 wt. % to 30 wt. %, such as from 10 wt. % to 30 wt. %, based on 100 wt. % of the aluminum alloy composition.

The aluminum alloy composition may comprise the first component in an amount from 25 wt. % to 55 wt. %, such as from 30 wt. % to 55 wt. %, from 40 wt. % to 55 wt. %, or from 25 wt. % to 50 wt. %; the second component in an amount from 20 wt. % to 50 wt. %, such as from 20 wt. % to 45 wt. %, from 25 wt. % to 50 wt. %, or from 20 wt. % to 35 wt. %; and the optional third component (if present) in an amount from 0 wt. % to 25 wt. % or from 10 wt. % to 25 wt. %, based on 100 wt. % of the aluminum alloy composition.

The aluminum alloy composition may comprise the first component in an amount from 30 wt. % to 60 wt. %, such as from 33 wt. % to 57 wt. %, from 31 wt. % to 51 wt. %, or from 45 wt. % to 56 wt. %; the second component in an amount from 20 wt. % to 50 wt. %, such as from 29 wt. % to 49 wt. %, from 23 wt. % to 43 wt. %, or from 24 wt. % to 35 wt. %; and the optional third component (if present) in an amount from 0 wt. % to 20 wt. %, or from 9 wt. % to 20 wt. %, based on 100 wt. % of the aluminum alloy composition.

The combination of the first component comprising recycled material, the second component comprising non-recycled material, and the optional third component comprising mill scrap may form an aluminum alloy composition that is a 5xxx series aluminum alloy composition. For example, the combination of the first component comprising recycled material, the second component comprising non-recycled material, and the optional third component comprising mill scrap may form an aluminum alloy composition that is AA 5182. When the aluminum alloy composition comprising the first component, the second component, and the optional third component is AA 5182, the aluminum alloy composition comprises not greater than 0.2 wt. % Si, not greater than 0.35 wt. % Fe, not greater than 0.15 wt. % Cu, from 0.20 wt. % to 0.50 wt. % Mn, from 4.0 wt. % to 5.0 wt. % Mg, not greater than 0.10 wt. % chromium (Cr), not greater than 0.25 wt. % zinc (Zn), not greater than 0.10 wt. % Ti, and not greater than 0.15 wt. % other elements, with the balance being aluminum to obtain an elemental composition of 100 wt. %. As used herein, “other elements” refers to elements that are not intentionally added to the aluminum alloy composition and may comprise, but are not limited to sodium, calcium, and combinations thereof.

The aluminum alloy composition described herein may be used to form an aluminum alloy sheet. The aluminum alloy sheet may be a coated aluminum alloy sheet. The aluminum alloy sheet may be coated on both sides. The coated aluminum alloy sheet may have a tensile yield strength (“TYS”) of from 45 kilopound per square inch (“ksi”) to 57 ksi, for example from 45.0 ksi to 57.0 ksi, or from 48 ksi to 55 ksi, such as from 48.0 ksi to 55.0 ksi. As used herein, “tensile yield strength” or “TYS” is defined as the load at 0.2% offset yield measured in the longitudinal direction divided by the original cross sectional area of the tested specimen.

The present invention also relates to a method of making an aluminum alloy sheet. The method comprises: providing an aluminum alloy composition; casting the aluminum alloy composition to produce an aluminum alloy ingot; rolling the aluminum alloy ingot to produce an aluminum alloy sheet; and optionally coating the aluminum alloy sheet to produce a coated aluminum alloy sheet. The aluminum alloy composition comprises a first component comprising recycled material, a second component comprising non-recycled material, and optionally a third component comprising mill scrap. The aluminum alloy composition comprises a recycled content of at least 30%. The aluminum alloy composition may be any aluminum alloy composition as described herein. The aluminum alloy sheet may be any of the aluminum alloy sheets described herein. The coated aluminum alloy sheet may be any of the coated aluminum alloy sheets described herein. The coated aluminum alloy sheet may have a TYS of from 45 ksi to 57 ksi, for example from 45.0 ksi to 57.0 ksi, or from 48 ksi to 55 ksi, for example from 48.0 ksi to 55.0 ksi.

The present invention also relates to a method of making an aluminum alloy composition. The method comprises: obtaining a first component; obtaining a second component; melting the first component; melting the second component; blending the first component and the second component together to form the aluminum alloy composition. The first component comprises recycled material and the second component comprises non-recycled material. The aluminum alloy composition comprises a recycled content of at least 30%. The aluminum alloy composition may further comprise a third component comprising mill scrap. The third component may be melted and the third component may be blended with the first component and the second component to form the aluminum alloy composition. The aluminum alloy composition may be any of the aluminum alloy compositions as described herein.

The first component comprising recycled material, the second component comprising non-recycled material, and the optional third component comprising mill scrap may be melted and blended together to form the aluminum alloy composition. The first component, second component, and optional third component may be melted using techniques known in the art of aluminum alloy manufacture. The first component, the second component, and the optional third component may be melted together simultaneously. The first component may be melted first and the second component and the optional third component may be added to the melted first component. The first component, the second component, and the optional third component may be separately melted and then blended together. The first component, the second component, and the optional third component may be obtained in an already melted state. The first component, the second component, and the optional third component may be blended to form the aluminum alloy composition using techniques known in the art of aluminum alloy manufacture. The melting and blending of the first component, the second component, and optional third component may be completed in any order.

The aluminum alloy composition may be cast into an aluminum alloy ingot. The aluminum alloy composition used to cast the ingot may be any of the aluminum alloy compositions described herein. The surface of the aluminum alloy ingot may be optionally scalped prior to the hot rolling process. The aluminum alloy ingot may be heated prior to hot rolling. The aluminum alloy ingot may not be heated prior to hot rolling. The aluminum alloy ingot is hot rolled to form an intermediate aluminum alloy sheet. The intermediate aluminum alloy sheet may then be cold rolled to obtain a final aluminum alloy sheet. The final aluminum alloy sheet may have a thickness in the range of at least 0.0060 inch, such as from 0.0060 inch to 0.0200 inch, or from 0.0078 inch to 0.0160 inch.

The aluminum alloy sheet may be a coated with a coating composition to form a coated aluminum alloy sheet. Both sides of the aluminum alloy sheet may be coated. The coating composition may be any suitable coating composition. The coating composition used to form the coating may be applied by any suitable technique that replaces the air at the aluminum alloy sheet surface with a coating, including but not limited to: roll coating, spray coating, rod coating, curtain coating, gravure coating, slot coating, knife coating, extrusion coating, laminating, and combinations thereof. The aluminum alloy sheet may be cleaned by any suitable technique prior to application of the coating composition. The aluminum alloy sheet may be pre-treated by any suitable technique after cleaning and prior to application of the coating composition. Following the application of the coating composition, the coated aluminum alloy sheet may be heated to facilitate the curing of the coating. The coated aluminum alloy sheet may have a TYS of from 45 ksi to 57 ksi, for example from 45.0 ksi to 57.0 ksi, or from 48 ksi to 55 ksi, for example from 48.0 ksi to 55.0 ksi.

The present invention is also directed to a method of making an aluminum alloy package, wherein the aluminum alloy package is a beverage container end. The method comprises: obtaining an aluminum alloy sheet; and forming the aluminum alloy sheet into an aluminum alloy package. The aluminum alloy sheet comprises an aluminum alloy composition comprising a first component comprising recycled material and a second component comprising non-recycled material. The aluminum alloy composition comprises a recycled content of at least 30%. The aluminum alloy composition may further comprise an optional third component comprising mill scrap. The aluminum alloy composition used to form the aluminum alloy sheet may be any of the aluminum alloy compositions as described herein. The aluminum alloy sheet may be any of the aluminum alloy sheets described herein.

The present invention is also directed to a method of making an aluminum alloy package, wherein the aluminum alloy package is a beverage container end. The method comprises: obtaining an aluminum alloy sheet; coating the aluminum alloy sheet to form a coated aluminum alloy sheet; and forming the coated aluminum alloy sheet into an aluminum alloy package. The aluminum alloy sheet comprises an aluminum alloy composition comprises a first component comprising recycled material and a second component comprising non-recycled material. The aluminum alloy composition comprises a recycled content of at least 30%. The aluminum alloy composition may further comprise an optional third component comprising mill scrap. The aluminum alloy composition used to form the aluminum alloy sheet or the coated aluminum alloy sheet may be any of the aluminum alloy compositions as described herein. The aluminum alloy sheet or the coated aluminum alloy sheet used to form the aluminum alloy package may be any of the aluminum alloy sheets described herein. The coated aluminum alloy sheet may have a TYS of from 45 ksi to 57 ksi, for example from 45.0 ksi to 57.0 ksi, or from 48 ksi to 55 ksi, for example from 48.0 ksi to 55.0 ksi.

To form an aluminum alloy beverage container end, the aluminum alloy sheet or the coated aluminum alloy sheet may be used to form an aluminum alloy blank. The aluminum alloy blank may be used to form an aluminum alloy beverage container end shell. The aluminum alloy beverage container end shell may be finished by curling. The aluminum alloy beverage container end shell may converted to have an easy opening and a tab attached to a portion of the aluminum alloy beverage container end shell to form the aluminum alloy beverage container end.

The following numbered clauses are illustrative of various aspects of the invention:

Clause 1: An aluminum alloy sheet comprising: an aluminum alloy composition comprising: a first component comprising recycled material; and a second component comprising non-recycled material; and wherein the aluminum alloy composition comprises a recycled content of at least 30%.

Clause 2: The aluminum alloy sheet of clause 1, wherein the recycled content is at least 40%, preferably at least 45%, more preferably at least 50%, and most preferably at least 70%.

Clause 3: The aluminum alloy sheet of clause 1 or 2, wherein the recycled content is not greater than 75%.

Clause 4: The aluminum alloy sheet of any one of clauses 1 to 3, further comprising a third component comprising mill scrap.

Clause 5: The aluminum alloy sheet of clause 4, wherein the mill scrap is selected from the group consisting of ingot scrap, casting scrap, remelted scrap ingot (RSI), hot roll processing scrap, cold roll processing scrap, uncoated coil scrap, coated coil scrap, and combinations thereof.

Clause 6: The aluminum alloy sheet of clause 4, wherein the third component comprises not more than 40 wt. % of the aluminum alloy composition, such as not more than 35 wt. % of the aluminum alloy composition, such as not more than 30 wt. % of the aluminum alloy composition, such as not more than 25 wt. % of the aluminum alloy composition, or such as not more than 20 wt. % of the aluminum alloy composition, based on 100 wt. % of the aluminum alloy composition.

Clause 7: The aluminum alloy sheet of any one of clauses 1 to 6, wherein the recycled material is selected from the group consisting of scrap Aluminum Association (AA) 5x54, scrap AA 5154, scrap AA 5254, scrap AA 5354, scrap AA 5454, scrap AA 5554, scrap AA 5654, scrap AA 5754, scrap AA 5854, or scrap AA 5954, scrap AA 5457, scrap AA 5085, scrap AA 5083, scrap AA 5086, scrap AA 5052, scrap AA 5352, scrap AA 5182, scrap AA 5042, scrap AA 5086, RSI, post-industrial scrap, pre-consumer scrap, post-consumer scrap, Class I scrap, Class II scrap, Class III scrap, Class IV scrap, used beverage cans, and combinations thereof.

Clause 8: The aluminum alloy sheet of any one of clauses 1 to 7, wherein the recycled material comprises used beverage cans.

Clause 9: The aluminum alloy sheet of any one of clauses 1 to 8, wherein the non-recycled material comprises prime aluminum, an alloying element, or combinations thereof.

Clause 10: The aluminum alloy sheet of 1 to 9, wherein the non-recycled material comprises prime aluminum and an alloying element.

Clause 11: The aluminum alloy sheet of clause 9 or 10, wherein the prime aluminum comprises less than or equal to 0.16 weight percent (wt. %) silicon (Si) and less than or equal to 0.25 wt. % iron (Fc).

Clause 12: The aluminum alloy sheet of claim 9 or 10, wherein the prime aluminum comprises less than or equal to 0.10 wt. % Si and less than or equal to 0.20 wt. % Fe, less than or equal to 0.10 wt. % Si and less than or equal to 0.15 wt. % Fe, less than or equal to 0.06 wt. % Si and less than or equal to 0.10 wt. % Fe, less than or equal to 0.04 wt. % Si and less than or equal to 0.06 wt. % Fe, or less than or equal to 0.02 wt. % Si and less than or equal to 0.02 wt. % Fe.

Clause 13: The aluminum alloy sheet of clause 9 or 10, wherein the alloying element is selected from the group consisting of silicon, iron, copper, magnesium, manganese, titanium, and combinations thereof.

Clause 14: The aluminum alloy sheet of clause 9 or 10, wherein the alloying element comprises magnesium, manganese, copper, or combinations thereof.

Clause 15: The aluminum alloy sheet of any one of clauses 1 to 14, wherein the aluminum alloy composition is a 5xxx series aluminum alloy.

Clause 16: The aluminum alloy sheet of any one of clauses 1 to 15, wherein the aluminum alloy composition is AA 5182.

Clause 17: The aluminum alloy sheet of any one of clauses 1 to 16, wherein the aluminum alloy sheet is a coated aluminum alloy sheet.

Clause 18: The aluminum alloy sheet of clause 17, wherein the coated aluminum alloy sheet comprises a tensile yield strength (TYS) of from 45 ksi to 57 ksi, or such as from 48 ksi to 55 ksi.

Clause 19: An aluminum alloy composition comprising: a first component comprising recycled material; and a second component comprising non-recycled material, wherein the aluminum alloy composition comprises a recycled content of at least 30%.

Clause 20: The aluminum alloy composition of clause 19, wherein the recycled content is at least 40%, preferably at least 45%, more preferably at least 50%, and most preferably at least 70%.

Clause 21: The aluminum alloy composition of clause 19 or 20, wherein the recycled content is not greater than 75%.

Clause 22: The aluminum alloy composition of any one of clauses 19 to 21, further comprising a third component comprising mill scrap.

Clause 23: The aluminum alloy composition of clause 22, wherein the mill scrap is selected from the group consisting of ingot scrap, casting scrap, RSI, hot roll processing scrap, cold roll processing scrap, uncoated coil scrap, coated coil scrap, and combinations thereof.

Clause 24: The aluminum alloy composition of clause 22, wherein the third component comprises not more than 40 wt. % of the aluminum alloy composition, such as not more than 35 wt. % of the aluminum alloy composition, such as not more than 30 wt. % of the aluminum alloy composition such as not more than 25 wt. % of the aluminum alloy composition, or such as not more than 20 wt. % of the aluminum alloy composition, based on 100 wt. % of the aluminum alloy composition.

Clause 25: The aluminum alloy composition of any one of claims 19 to 24, wherein the recycled material is selected from the group consisting of scrap AA 5x54, scrap AA 5154, scrap AA 5254, scrap AA 5354, scrap AA 5454, scrap AA 5554, scrap AA 5654, scrap AA 5754, scrap AA 5854, or scrap AA 5954, scrap AA 5457, scrap AA 5085, scrap AA 5083, scrap AA 5086, scrap AA 5052, scrap AA 5352, scrap AA 5182, scrap AA 5042, scrap AA 5086, post-industrial scrap, pre-consumer scrap, post-consumer scrap, Class I scrap, Class II scrap, Class III scrap, Class IV scrap, used beverage cans, and combinations thereof.

Clause 26: The aluminum alloy composition of any one of clauses 19 to 25, wherein the recycled material comprises used beverage cans.

Clause 27: The aluminum alloy composition of any one of clauses 19 to 26, wherein the non-recycled material comprises prime aluminum, an alloying element, or combinations thereof.

Clause 28: The aluminum alloy composition of any one of clauses 19 to 27, wherein the non-recycled material comprises prime aluminum and an alloying element.

Clause 29: The aluminum alloy composition of clause 27 or 28, wherein the prime aluminum comprises less than or equal to 0.16 wt. % Si and less than or equal to 0.25 wt. % Fc.

Clause 30: The aluminum alloy composition of clause 27 or 28, wherein the prime aluminum comprises less than or equal to 0.10 wt. % Si and less than or equal to 0.20 wt. % Fe, less than or equal to 0.10 wt. % Si and less than or equal to 0.15 wt. % Fe, less than or equal to 0.06 wt. % Si and less than or equal to 0.10 wt. % Fe, less than or equal to 0.04 wt. % Si and less than or equal to 0.06 wt. % Fe, or less than or equal to 0.02 wt. % Si and less than or equal to 0.02 wt. % Fc.

Clause 31: The aluminum alloy composition of clause 27 or 28, wherein the alloying element is selected from the group consisting of silicon, iron, copper, magnesium, manganese, titanium, and combinations thereof.

Clause 32: The aluminum alloy composition of clause 27 or 28, wherein the alloying element comprises magnesium, manganese, copper, or combinations thereof.

Clause 33: The aluminum alloy composition of any one of clauses 19 to 32, wherein the aluminum alloy composition is a 5xxx series aluminum alloy.

Clause 34: The aluminum alloy composition of any one of clauses 19 to 33, wherein the aluminum alloy composition is AA 5182.

Clause 35: A method of making an aluminum alloy sheet, the method comprising: providing an aluminum alloy composition, wherein the aluminum alloy composition comprises: a first component comprising recycled material; and a second component comprising non-recycled material; wherein the aluminum alloy composition comprises a recycled content of at least 30%; casting the aluminum alloy composition to produce an aluminum alloy ingot; and rolling the aluminum alloy ingot to produce an aluminum alloy sheet.

Clause 36: The method of clause 35, wherein the recycled content is at least 40%, preferably at least 45%, more preferably at least 50%, and most preferably at least 70%.

Clause 37: The method of clause 35 or 36, wherein the recycled content is not greater than 75%.

Clause 38: The method of any one of clauses 35 to 37, wherein the aluminum alloy composition further comprises a third component comprising mill scrap.

Clause 39: The method of clause 38, wherein the mill scrap is selected from the group consisting of ingot scrap, casting scrap, RSI, hot roll processing scrap, cold roll processing scrap, uncoated coil scrap, coated coil scrap, and combinations thereof.

Clause 40: The method of clause 38, wherein the third component comprises not more than 40 wt. % of the aluminum alloy composition, such as not more than 35 wt. % of the aluminum alloy composition, such as not more than 30 wt. % of the aluminum alloy composition, such as not more than 25 wt. % of the aluminum alloy composition, or such as not more than 20 wt. % of the aluminum alloy composition, based on 100 wt. % of the aluminum alloy composition.

Clause 41: The method of any one of clauses 35 to 40, wherein the recycled material is selected from the group consisting of scrap AA 5x54, scrap AA 5154, scrap AA 5254, scrap AA 5354, scrap AA 5454, scrap AA 5554, scrap AA 5654, scrap AA 5754, scrap AA 5854, or scrap AA 5954, scrap AA 5457, scrap AA 5085, scrap AA 5083, scrap AA 5086, scrap AA 5052, scrap AA 5352, scrap AA 5182, scrap AA 5042, scrap AA 5086, post-industrial scrap, pre-consumer scrap, post-consumer scrap, Class I scrap, Class II scrap, Class III scrap, Class IV scrap, used beverage cans, and combinations thereof.

Clause 42: The method of any one of clauses 35 to 41, wherein the recycled material comprises used beverage cans.

Clause 43: The method of any one of clauses 35 to 42, wherein the non-recycled material comprises prime aluminum, an alloying element, or combinations thereof.

Clause 44: The method of any one of clauses 35 to 43, wherein the non-recycled material comprises prime aluminum and an alloying element.

Clause 45: The method of clause 43 or 44, wherein the prime aluminum comprises less than or equal to 0.16 wt. % Si and less than or equal to 0.25 wt. % Fe.

Clause 46: The method of clause 43 or 44, wherein the prime aluminum comprises less than or equal to 0.10 wt. % Si and less than or equal to 0.20 wt. % Fe, less than or equal to 0.10 wt. % Si and less than or equal to 0.15 wt. % Fe, less than or equal to 0.06 wt. % Si and less than or equal to 0.10 wt. % Fe, less than or equal to 0.04 wt. % Si and less than or equal to 0.06 wt. % Fe, or less than or equal to 0.02 wt. % Si and less than or equal to 0.02 wt. % Fe.

Clause 47: The method of clause 43 or 44, wherein the alloying element is selected from the group consisting of silicon, iron, copper, magnesium, manganese, titanium, and combinations thereof.

Clause 48: The method of clause 43 or 44, wherein the alloying element comprises magnesium, manganese, copper, or combinations thereof.

Clause 49: The method of any one of clauses 35 to 48, wherein the aluminum alloy composition is a 5xxx series aluminum alloy.

Clause 50: The method of any one of clauses 35 to 49, wherein the aluminum alloy composition is AA 5182.

Clause 51: The method of any one of clauses 35 to 50, further comprising coating the aluminum alloy sheet to form a coated aluminum alloy sheet.

Clause 52: The method of clause 51, wherein the coated aluminum alloy sheet comprises a TYS of from 45 ksi to 57 ksi, or such as from 48 ksi to 55 ksi.

Clause 53: A method of making an aluminum alloy package, the method comprising: obtaining an aluminum alloy sheet, wherein the aluminum alloy sheet comprises an aluminum alloy composition comprising: a first component comprising recycled material; and a second component comprising non-recycled material, wherein the aluminum alloy composition comprises a recycled content of at least 30%; and forming the aluminum alloy sheet into an aluminum alloy package, wherein the aluminum alloy package is a beverage container end.

Clause 54: The method of clause 53, wherein the recycled content is at least 40%, preferably at least 45%, more preferably at least 50%, and most preferably at least 70%.

Clause 55: The method of clause 53 or 54, wherein the recycled content is not greater than 75%.

Clause 56: The method of any one of clauses 53 to 55, wherein the aluminum alloy composition further comprises a third component comprising mill scrap.

Clause 57: The method of clause 56, wherein the mill scrap is selected from the group consisting of ingot scrap, casting scrap, RSI, hot roll processing scrap, cold roll processing scrap, uncoated coil scrap, coated coil scrap, and combinations thereof.

Clause 58: The method of clause 56, wherein the third component comprises not more than 40 wt. % of the aluminum alloy composition, such as not more than 35 wt. % of the aluminum alloy composition, such as not more than 30 wt. % of the aluminum alloy composition, such as not more than 25 wt. % of the aluminum alloy composition, or such as not more than 20 wt. % of the aluminum alloy composition, based on 100 wt. % of the aluminum alloy composition.

Clause 59: The method of any one of claims 53 to 58, wherein the recycled material is selected from the group consisting of scrap AA 5x54, scrap AA 5154, scrap AA 5254, scrap AA 5354, scrap AA 5454, scrap AA 5554, scrap AA 5654, scrap AA 5754, scrap AA 5854, or scrap AA 5954, scrap AA 5457, scrap AA 5085, scrap AA 5083, scrap AA 5086, scrap AA 5052, scrap AA 5352, scrap AA 5182, scrap AA 5042, scrap AA 5086, post-industrial scrap, postconsumer scrap, Class I scrap, Class II scrap, Class III scrap, Class IV scrap, used beverage cans, and combinations thereof.

Clause 60: The method of any one of clauses 53 to 59, wherein the recycled material comprises used beverage cans.

Clause 61: The method of any one of clauses 53 to 60, wherein the non-recycled material comprises prime aluminum, an alloying element, or combinations thereof.

Clause 62: The method of any one of clauses 53 to 61, wherein the non-recycled material comprises prime aluminum and an alloying element.

Clause 63: The method of clause 61 or 62, wherein the prime aluminum comprises less than or equal to 0.16 wt. % Si and less than or equal to 0.25 wt. % Fc.

Clause 64: The method of clause 61 or 62, wherein the prime aluminum comprises less than or equal to 0.10 wt. % Si and less than or equal to 0.20 wt. % Fe, less than or equal to 0.10 wt. % Si and less than or equal to 0.15 wt. % Fe, less than or equal to 0.06 wt. % Si and less than or equal to 0.10 wt. % Fe, less than or equal to 0.04 wt. % Si and less than or equal to 0.06 wt. % Fe, or less than or equal to 0.02 wt. % Si and less than or equal to 0.02 wt. % Fe.

Clause 65: The method of clause 61 or 62, wherein the alloying element is selected from the group consisting of silicon, iron, copper, magnesium, manganese, titanium, and combinations thereof.

Clause 66: The method of clause 61 or 62, wherein the alloying element comprises magnesium, manganese, copper, or combinations thereof.

Clause 67: The method of any one of clauses 53 to 66, wherein the aluminum alloy composition is a 5xxx series aluminum alloy.

Clause 68: The method of any one of clauses 53 to 67, wherein the aluminum alloy composition is AA 5182.

Clause 69: The method of any one of clauses 53 to 68, further comprising coating the aluminum alloy sheet to form a coated aluminum alloy sheet.

Clause 70: The method of clause 69, wherein the coated aluminum alloy sheet comprises a TYS of from 45 ksi to 57 ksi, or such as from 48 ksi to 55 ksi.

Clause 71: A method of making an aluminum alloy composition, the method comprising: obtaining a first component, wherein the first component comprises recycled material; obtaining a second component, wherein the second component comprises non-recycled material; melting the first component; melting the second component; blending the first component and the second component together to form the aluminum alloy composition, wherein the aluminum alloy composition comprises a recycled content of at least 30%.

Clause 72: The method of clause 71, wherein the recycled content is at least 40%, preferably at least 45%, more preferably at least 50%, and most preferably at least 70%.

Clause 73: The method of clause 71 or 72, wherein the recycled content is not greater than 75%.

Clause 74: The method of any one of clauses 71 to 73, further comprising: obtaining a third component, wherein the third component comprises mill scrap; melting the third component;

and blending the third component with the first component and the second component to form the aluminum alloy composition.

Clause 75: The method of clause 74, wherein the mill scrap is selected from the group consisting of ingot scrap, casting scrap, RSI, hot roll processing scrap, cold roll processing scrap, uncoated coil scrap, coated coil scrap, and combinations thereof.

Clause 76: The method of clause 74, wherein the third component comprises not more than 40 wt. % of the aluminum alloy composition, such as not more than 35 wt. % of the aluminum alloy composition, such as not more than 30 wt. % of the aluminum alloy composition, such as not more than 25 wt. % of the aluminum alloy composition, or such as not more than 20 wt. % of the aluminum alloy composition, based on 100 wt. % of the aluminum alloy composition.

Clause 77: The method of any one of clauses 71 to 76, wherein the recycled material is selected from the group consisting of scrap AA 5x54, scrap AA 5154, scrap AA 5254, scrap AA 5354, scrap AA 5454, scrap AA 5554, scrap AA 5654, scrap AA 5754, scrap AA 5854, or scrap AA 5954, scrap AA 5457, scrap AA 5085, scrap AA 5083, scrap AA 5086, scrap AA 5052, scrap AA 5352, scrap AA 5182, scrap AA 5042, scrap AA 5086, post-industrial scrap, pre-consumer scrap, post-consumer scrap, Class I scrap, Class II scrap, Class III scrap, Class IV scrap, used beverage cans, and combinations thereof.

Clause 78: The method of any one of clauses 71 to 77, wherein the recycled material comprises used beverage cans.

Clause 79: The method of any one of clauses 71 to 78, wherein the non-recycled material comprises prime aluminum, an alloying element, or combinations thereof.

Clause 80: The method of any one of clauses 71 to 79, wherein the non-recycled material comprises prime aluminum and an alloying element.

Clause 81: The method of clause 79 or 80, wherein the prime aluminum comprises less than or equal to 0.16 wt. % Si and less than or equal to 0.25 wt. % Fc.

Clause 82: The method of clause 79 or 80, wherein the prime aluminum comprises less than or equal to 0.10 wt. % Si and less than or equal to 0.20 wt. % Fe, less than or equal to 0.10 wt. % Si and less than or equal to 0.15 wt. % Fe, less than or equal to 0.06 wt. % Si and not greater than 0.1 wt. % Fe, less than or equal to 0.04 wt. % Si and less than or equal to 0.06 wt. % Fe, or less than or equal to 0.02 wt. % Si and less than or equal to 0.02 wt. % Fc.

Clause 83: The method of clause 79 or 80, wherein the alloying element is selected from the group consisting of silicon, iron, copper, magnesium, manganese, titanium, and combinations thereof.

Clause 84: The method of clause 79 or 80, wherein the alloying element comprises magnesium, manganese, copper, or combinations thereof.

Clause 85: The method of any one of clauses 71 to 84, wherein the aluminum alloy composition is a 5xxx series aluminum alloy.

Clause 86: The method of any one of clauses 71 to 85, wherein the aluminum alloy composition is AA 5182.

It will be readily appreciated by those skilled in the art that modifications may be made to the invention without departing from the concepts disclosed in the foregoing description. Accordingly, the particular embodiments described in detail herein are illustrative only and are not limiting to the scope of the invention, which is to be given the full breadth of the appended claims and any and all equivalents thereof.

What is claimed is:

1. An aluminum alloy sheet comprising:
an aluminum alloy composition comprising:
a first component comprising recycled material; and
a second component comprising non-recycled material;
wherein the aluminum alloy composition comprises a recycled content of at least 30%.

2. The aluminum alloy sheet of claim 1, wherein the recycled content is at least 40%, and
wherein the recycled content is not greater than 75%.

3. The aluminum alloy sheet of claim 1, further comprising a third component comprising mill scrap,
wherein the mill scrap is selected from the group consisting of ingot scrap, casting scrap, remelted scrap ingot (RSI), hot roll processing scrap, cold roll processing scrap, uncoated coil scrap, coated coil scrap, and combinations thereof, and
wherein the third component comprises not more than 40 wt. % of the aluminum alloy composition.

4. The aluminum alloy sheet of claim 1, wherein the recycled material is selected from the group consisting of scrap Aluminum Association (AA) 5x54, scrap AA 5154, scrap AA 5254, scrap AA 5354, scrap AA 5454, scrap AA 5554, scrap AA 5654, scrap AA 5754, scrap AA 5854, or scrap AA 5954, scrap AA 5457, scrap AA 5085, scrap AA 5083, scrap AA 5086, scrap AA 5052, scrap AA 5352, scrap AA 5182, scrap AA 5042, scrap AA 5086, RSI, post-industrial scrap, pre-consumer scrap, post-consumer scrap, Class I scrap, Class II scrap, Class III scrap, Class IV scrap, used beverage cans, and combinations thereof.

5. The aluminum alloy sheet of claim 1, wherein the non-recycled material comprises prime aluminum, an alloying element, or combinations thereof.

6. The aluminum alloy sheet of claim 5, wherein the prime aluminum comprises less than or equal to 0.16 weight percent (wt. %) silicon (Si) and less than or equal to 0.25 wt. % iron (Fe).

7. The aluminum alloy sheet of claim 5, wherein the prime aluminum comprises less than or equal to 0.10 wt. % Si and less than or equal to 0.20 wt. % Fe, less than or equal to 0.10 wt. % Si and less than or equal to 0.15 wt. % Fe, less than or equal to 0.06 wt. % Si and less than or equal to 0.10 wt. % Fe, less than or equal to 0.04 wt. % Si and less than or equal to 0.06 wt. % Fe, or less than or equal to 0.02 wt. % Si and less than or equal to 0.02 wt. % Fe.

8. The aluminum alloy sheet of claim 5, wherein the alloying element is selected from the group consisting of silicon, iron, copper, magnesium, manganese, titanium, and combinations thereof.

9. The aluminum alloy sheet of claim 1, wherein the aluminum alloy composition is a 5xxx series aluminum alloy.

10. The aluminum alloy sheet of claim 1, wherein the aluminum alloy sheet is a coated aluminum alloy sheet, and
wherein the coated aluminum alloy sheet comprises a tensile yield strength (TYS) of from 45 ksi to 57 ksi.

11. An aluminum alloy composition comprising:
a first component comprising recycled material; and
a second component comprising non-recycled material,
wherein the aluminum alloy composition comprises a recycled content of at least 30%.

12. The aluminum alloy composition of claim 11, wherein the recycled content is at least 40%, and
wherein the recycled content is not greater than 75%.

13. The aluminum alloy composition of claim 11, further comprising a third component comprising mill scrap,
wherein the mill scrap is selected from the group consisting of ingot scrap, casting scrap, RSI, hot roll processing scrap, cold roll processing scrap, uncoated coil scrap, coated coil scrap, and combinations thereof, and
wherein the third component comprises not more than 40 wt. % of the aluminum alloy composition.

14. The aluminum alloy composition of claim 11, wherein the recycled material is selected from the group consisting of scrap AA 5x54, scrap AA 5154, scrap AA 5254, scrap AA 5354, scrap AA 5454, scrap AA 5554, scrap AA 5654, scrap AA 5754, scrap AA 5854, or scrap AA 5954, scrap AA 5457, scrap AA 5085, scrap AA 5083, scrap AA 5086, scrap AA 5052, scrap AA 5352, scrap AA 5182, scrap AA 5042, scrap AA 5086, post-industrial scrap, pre-consumer scrap, post-consumer scrap, Class I scrap, Class II scrap, Class III scrap, Class IV scrap, used beverage cans, and combinations thereof.

15. The aluminum alloy composition of claim 11, wherein the non-recycled material comprises prime aluminum, an alloying element, or combinations thereof.

16. The aluminum alloy composition of claim 15, wherein the prime aluminum comprises less than or equal to 0.16 wt. % Si and less than or equal to 0.25 wt. % Fe.

17. The aluminum alloy composition of claim 15, wherein the prime aluminum comprises less than or equal to 0.10 wt. % Si and less than or equal to 0.20 wt. % Fe, less than or equal to 0.10 wt. % Si and less than or equal to 0.15 wt. % Fe, less than or equal to 0.06 wt. % Si and less than or equal to 0.10 wt. % Fe, less than or equal to 0.04 wt. % Si and less than or equal to 0.06 wt. % Fe, or less than or equal to 0.02 wt. % Si and less than or equal to 0.02 wt. % Fe.

18. The aluminum alloy composition of claim 15, wherein the alloying element is selected from the group consisting of silicon, iron, copper, magnesium, manganese, titanium, and combinations thereof.

19. The aluminum alloy composition of claim 11, wherein the aluminum alloy composition is a 5xxx series aluminum alloy.

20. A method of making an aluminum alloy sheet, the method comprising:
providing an aluminum alloy composition, wherein the aluminum alloy composition comprises:
a first component comprising recycled material; and
a second component comprising non-recycled material;
wherein the aluminum alloy composition comprises a recycled content of at least 30%;
casting the aluminum alloy composition to produce an aluminum alloy ingot; and
rolling the aluminum alloy ingot to produce an aluminum alloy sheet.
